(19) United States
(12) Patent Application Publication
(10) Pub. No.: US 2014/0139799 A1
(43) Pub. Date: May 22, 2014

(54) LIQUID CRYSTAL DISPLAY AND THE MANUFACTURING METHOD THEREOF

(71) Applicant: Liang XU, Shenzhen (CN)

(72) Inventor: Liang XU, Shenzhen (CN)

(73) Assignee: Shenzhen China Star Optoelectronics Technology Co., Ltd., Shenzhen, Guangdong (CN)

(21) Appl. No.: 13/806,966

(22) PCT Filed: Nov. 28, 2012
(86) PCT No.: PCT/CN2012/085390

§ 371 Date: Dec. 26, 2012

(30) Foreign Application Priority Data
Nov. 19, 2012 (CN) 201210467632.X

(51) Int. Cl. G02F 1/1362; G02F 1/1339

(52) U.S. Cl. CPC G02F 1/136286; G02F 1/1339
USPC 349/155; 349/158; 438/34

(57) ABSTRACT

A liquid crystal display is disclosed. The liquid crystal display includes: a glass substrate; a protrusive three-dimensional pattern layer is arranged on the glass substrate, and the three-dimensional pattern layer and the glass substrate form an acute angle; and a gate, a source, or a drain line arranged along an outer surface of the three-dimensional pattern layer. In addition, a manufacturing method of the liquid crystal display is also disclosed. The gate, the source, or the drain line is arranged in the three-dimensional form. In this way, the line width of the three-dimensional pattern layer is larger than that of the planar layer. At the same time, the blocked area of the three-dimensional pattern layer is only its projection on the glass substrate. Therefore, the line width is increased and the blocked area is not greatly increased.

### BACKGROUND OF THE INVENTION

This application claims priority to China Patent Application No. 201210467632.X filed on Nov. 19, 2012 entitled, LIQUID CRYSTAL DISPLAY AND THE MANUFACTURING METHOD THEREOF, all of the disclosures of which are incorporated herein by reference in their entirety.

1. Field of the Invention

Embodiments of the present disclosure relate to display technology, and more particularly to a liquid crystal display and the manufacturing method thereof.

2. Discussion of the Related Art

With the technology development, a plurality of display devices, such as LCD, PDP, OLED, are new options for consumers. Among the flat display devices, the LCD devices are more poplar than the CCFL devices due to the light, thin, energy-efficient attributes of TFT-LCD. In addition, the manufacturing process of TFT-LCD is quite mature, and thus the above advantages have brought the TFT-LCD into a main stream of display technology.

Brightness is a key attribute of the LCD, and the aperture rate determines the brightness of the LCD. The aperture rate relates to a ratio of the light transmission area to the dimension of the LCD. Lights emitted from the backlight plate may be blocked by components, such as the metallic lines, the TFT, and the storage capacitors, such that the aperture rate is not high. For large-scale TFT-LCD, as the resistance gets higher, thicker metallic lines or metallic lines with better conductive attributes, such as sliver and cooper, are needed. However, as the thickness of the metallic lines is limited, and the conductive attributes of the metallic lines is also limited by the material itself, the only solution is to increase the line width so as to reduce the aperture rate of the TFT-LCD.

### SUMMARY

The object of the claimed invention is to provide a liquid crystal display and the manufacturing method thereof.

In one aspect, a liquid crystal device includes: a glass substrate; a protrusive three-dimensional pattern layer being arranged on the glass substrate, and the three-dimensional pattern layer and the glass substrate form an acute angle; and a gate, a source, or a drain line being arranged along an outer surface of the three-dimensional pattern layer.

Wherein the three-dimensional pattern layer is arranged below the gate, the source, or the drain line.

Wherein the three-dimensional pattern layer includes a top surface, a down surface parallel to the top surface, and two sides connected between the top surface and the down surface, the two sides respectively form the acute angle a with the glass substrate, and the acute angle is of the range between 0 to 90 degrees.

Wherein the glass substrate includes a down glass substrate and an up glass substrate parallel to each other, the gate line is arranged on the down glass substrate, and the three-dimensional pattern layer is arranged in the area below thicker gate line.

Wherein a photo spacer is arranged between the three-dimensional pattern layer and the top glass substrate.

Wherein the three-dimensional pattern layer is arranged above the gate, the source, or the drain line with a recessed structure.

Wherein the three-dimensional pattern layer is the photo spacer.

Wherein the three-dimensional pattern layer is the photo spacer

Wherein the three-dimensional pattern layer is made by organic membrane, and is solidified by ultraviolet rays or heat.

Wherein the three-dimensional pattern layer is made by organic membrane, and is solidified by ultraviolet rays or heat.

Wherein the thickness of the three-dimensional pattern layer is of the range between 1 um to 10 um.

Wherein the thickness of the three-dimensional pattern layer is of the range between 1 um to 10 um.

In another aspect, a manufacturing method of a liquid crystal display includes: providing a glass substrate; arranging a protrusive three-dimensional pattern layer on the glass substrate, and the three-dimensional pattern layer and the glass substrate form an acute angle; and arranging a gate, a source, or a drain line along an outer surface of the three-dimensional pattern layer, and the three-dimensional pattern layer is below the gate, the source, or the drain lines.

Wherein the three-dimensional pattern layer includes a top surface, a down surface parallel to the top surface, and two sides connected between the top surface and the down surface, the two sides respectively form the acute angle α with the glass substrate, and the acute angle is of the range between 0 to 90 degrees.

Wherein the glass substrate includes a down glass substrate and an up glass substrate parallel to each other, and the gate line is arranged on the down glass substrate, and the three-dimensional pattern layer is arranged in the area below thicker gate line.

Wherein the method further comprises arranging a photo spacer between the three-dimensional pattern layer and the top glass substrate.

In another aspect, a manufacturing method of a liquid crystal display includes: providing a glass substrate; arranging a protrusive three-dimensional pattern layer on the glass substrate, and the three-dimensional pattern layer and the glass substrate form an acute angle; and arranging a gate, a source, or a drain line along an outer surface of the three-dimensional pattern layer, and the three-dimensional pattern layer is above the gate, the source, or the drain lines; and after the three-dimensional pattern layer is formed, portions of the three-dimensional pattern layer below the gate, source, or the drain lines are removed by exposure or development processes.

The gate, the source, or the drain line is arranged in the three-dimensional form. In this way, the line width of the three-dimensional pattern layer is larger than that of the planar layer. At the same time, the blocked area of the three-dimensional pattern layer is only its projection on the glass substrate. Therefore, the line width is increased and the blocked area is not greatly increased.

### BRIEF DESCRIPTION OF THE DRAWINGS

FIG. 1 is a cross-sectional view of the glass substrate of one conventional liquid crystal device.

FIG. 2 is a schematic view of the glass substrate in accordance with one embodiment.

FIG. 3 is a cross-sectional view of the liquid crystal device in accordance with a first embodiment.

FIG. 4 is a cross-sectional view of the liquid crystal device in accordance with a third embodiment.

FIG. 5 is a cross-sectional view of the liquid crystal device in accordance with a fifth embodiment.

### DETAILED DESCRIPTION OF THE EMBODIMENTS

Embodiments of the invention will now be described more fully hereinafter with reference to the accompanying drawings, in which embodiments of the invention are shown.

Usually, the gate layer, the source layer, or the drain layer is designed to be on a plane. In this way, the lights are blocked by the portions on which the metallic lines are arranged. In the embodiment, the gate layer, the source layer, or the drain layer is not arranged in the planar form. The metallic lines are in the three-dimensional form. In this way, the line width is increased and the blocked area is reduced.

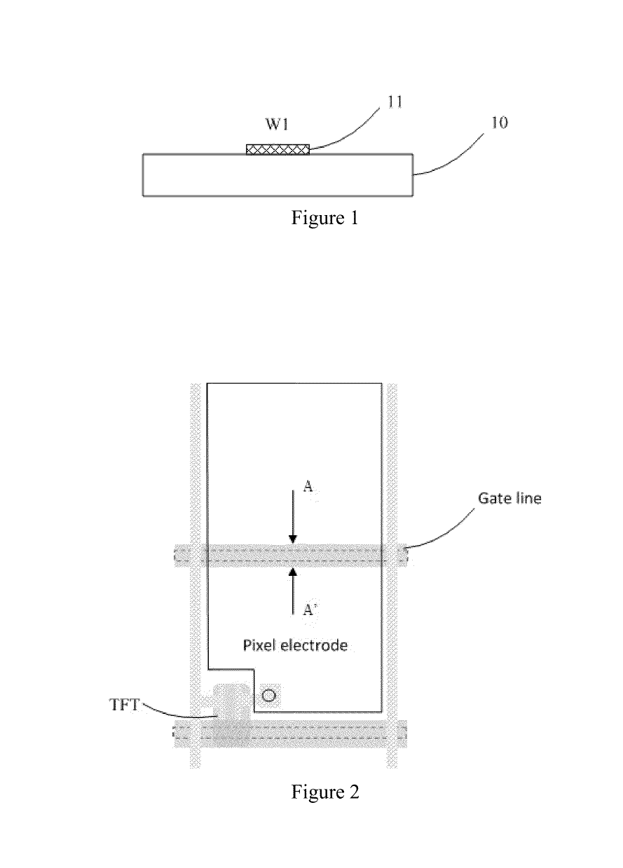

FIG. 1 is a cross-sectional view of the glass substrate of one conventional liquid crystal device. As shown, a gate line 11 is formed on a glass substrate 10 in a planar form. As stated, as the width W1 is increased, the dimension of the blocked area is increased such that the aperture rate is reduced.

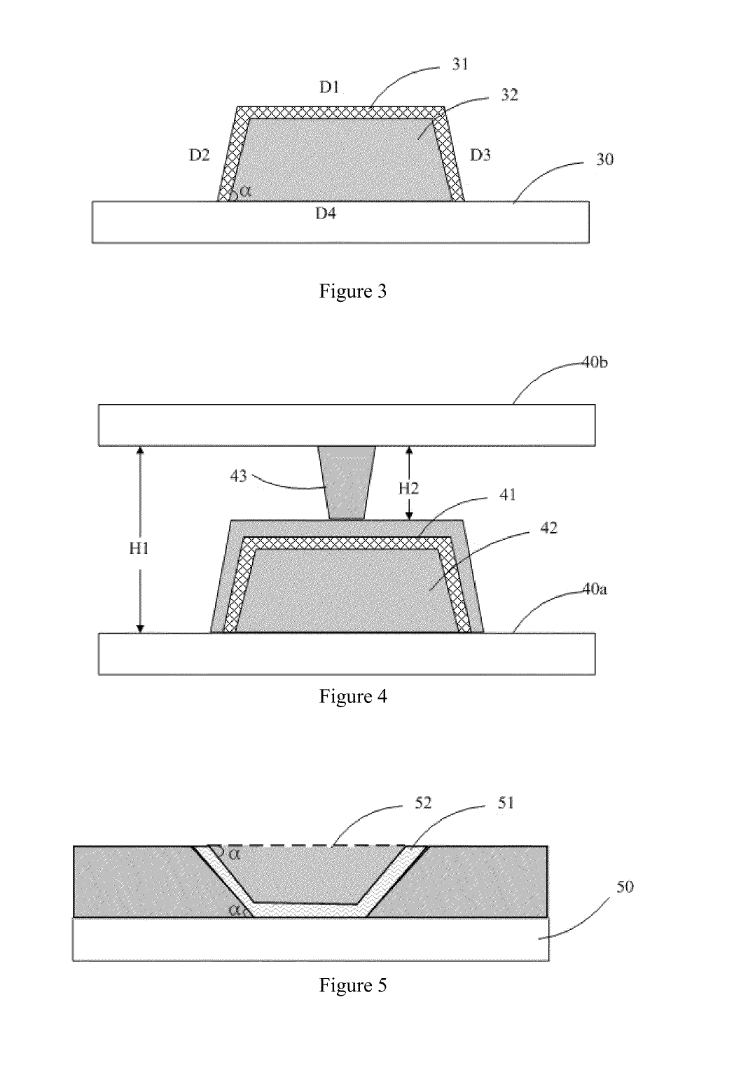

FIG. 2 is a schematic view of the glass substrate in accordance with one embodiment. Though the structure and the configuration of the glass substrate shown in FIG. 2 are the same with those of the typical glass substrate, the concrete structure of the glass substrate of the claimed invention is different from that of the typical one in view of FIGS. 3-5.

In the first embodiment, as shown in FIG. 3, the liquid crystal display includes a glass substrate 30 and a three-dimensional pattern layer 32 below a gate line 31. The three-dimensional pattern layer 32 and the glass substrate 30 form an acute angle α.

The three-dimensional pattern layer 32 is made by organic membrane. The organic membrane is solidified by ultraviolet rays or heat. The thickness of the three-dimensional pattern layer 32 is of the range between 1 um to 10 um.

The three-dimensional pattern layer 32 includes a top surface, a down surface parallel to the top surface, and two sides connected between the top surface and the down surface. The down surface bonds with the glass substrate 30. The two sides respectively form the acute angle α with the glass substrate 30, and the acute angle is of the range between 0 to 90 degrees. Preferably, the three-dimensional pattern layer 32 has a substantially trapezoid-shaped cross section.

Specifically, the gate line 31 is arranged along the top surface and the two sides of the three-dimensional pattern layer 32. The three-dimensional pattern layer 32 is protrusive from the glass substrate 30 such that it is in the three-dimensional form. In this way, the width of the gate line 31 equals to a sum of the width of the top surface (D1) and the two sides (D2, D3) as shown in FIG. 3. Comparing to the width of the gate line 31 in FIG. 1, the width of the gate line 31 in FIG. 3 is greatly increased so as to meet the requirements of large-scale product design. In another aspect, though the width of the gate line 31 is increased, the blocked area is only the projection of the three-dimensional pattern layer 32 on the glass substrate 30. That is, the blocked area equals the width of the bottom of the three-dimensional pattern layer 32 (“D4) in FIG. 3.

The aperture ratio of the liquid crystal device of FIG. 3 and FIG. 1 are compared below.

The liquid crystal display includes pixels, and as an illustrative example, the width and the height of the pixels are respectively 100 um and 300 um.

For the typical liquid crystal device as shown in FIG. 1, when the width of the gate line and the common line equal to 15 um, the blocked area ratio of the gate line and the common line is calculated as below:

(15+15)/300=10%;

For the liquid crystal device as shown in FIG. 3, assuming the three-dimensional pattern layer 32 is substantially isosceles trapezoid-shaped, the height equals to 4.3 um, the acute angle α equals to 60 degrees, D1 equals to 5 um, D4 equals to 10 um, and the D2 and the D3 are calculated as below:

D2=D3=(D4−D1)/2* Cos 60°=5 um

The width of the metallic lines equals to a sum of D1, D2 and D3, which is 15 um, and the width of the blocked area of the metallic line equals to D4, which is 10 um. As such, the blocked area ratio of the gate line and the common line is calculated as below:

(10+10)/300=6.7%;

It can be seen that the aperture rate is increased for 3.3%. While the width of the gate line may be larger than 15 um for products, the increased aperture rate may be higher than 3.3%.

It can be understood that larger acute angle α is preferable such that the width of the gate line 31 is close to the width of the blocked area. That is, the sum of D1, D2 and D3 is quite close to D4. In this way, the blocked area ratio of the gate line and the common line is decreased and the aperture rate is increased.

A second embodiment relates to a manufacturing method of the liquid crystal device of the first embodiment. The manufacturing method includes the following steps. Firstly, a glass substrate is provided. A protrusive three-dimensional pattern layer is arranged above the glass substrate and below the gate line. The three-dimensional pattern layer and the glass substrate form the acute angle α. After being formed, the three-dimensional pattern layer is retained below the gate lines, the source line or the drain line by exposure or development processes. The gates and other layers are formed after the three-dimensional pattern layer is formed.

FIG. 4 is a cross-sectional view of the liquid crystal device in accordance with a third embodiment. In the third embodiment, the three-dimensional pattern layer 42 is not arranged in all of the portions below the gate line. The three-dimensional pattern layer 42 is arranged in the area below thicker gate line 41. In addition, a photo spacer 43 is arranged on the three-dimensional pattern layer 42.

In the embodiment, the liquid crystal display includes a glass substrate 40 having a down glass substrate 40a and an up glass substrate 40b parallel to each other. The gate line 41 is arranged on the down glass substrate 40a. The three-dimensional pattern layer 42 is arranged in the area below thicker gate line 41. The three-dimensional pattern layer 42 and the down glass substrate 40a form the acute angle α. In addition, the photo spacer is arranged between the three-dimensional pattern layer 42 and the up glass substrate 40b.

The photo spacer 43 is made of photoreactive material. The photo spacer 43 is for supporting the down glass substrate 40a and the up glass substrate 40b. The photo spacer 43 has to be uniformly arranged or the coupling of the photo spacer 43 may block the lights. In addition, the photo spacer 43 may not able to keep an appropriate gap between the down glass substrate 40a and the up glass substrate 40b. Under the circumstance, the electric field is not uniformly distributed such that the gray level performance of the liquid crystals may be affected.

As the three-dimensional pattern layer 42 is only arranged in the area below thicker gate line 41, the thickness of the photo spacer 43 is reduced. That is, the thickness of the photo spacer 43 may be reduced from the distance H1 between the down glass substrate 40a and the up glass substrate 40b to the distance H2 between the top surface of the three-dimensional pattern layer 42 and the up glass substrate 40b.

In other embodiments, the three-dimensional pattern layer 42 may be the photo spacer. As such, the photo spacer is not needed, and the manufacturing process and materials are simplified. It is to be understood that the thickness of the three-dimensional pattern layer 42 is determined by the height of the photo spacer.

A fourth embodiment relates to a manufacturing method of the liquid crystal device of the third embodiment. The manufacturing method includes the following steps. Firstly, a glass substrate is provided. The glass substrate includes an up glass substrate and a down glass substrate parallel to each other. A three-dimensional pattern layer is protrusively arranged above the down glass substrate and below thicker gate line. After being formed, the three-dimensional pattern layer is retained below the gate lines, the source line or the drain line by exposure or development processes. The gates and other layers are formed after the formation of the three-dimensional pattern layer is completed. In addition, the photo spacer is arranged between the three-dimensional pattern layer and the up glass substrate.

FIG. 5 is a cross-sectional view of the liquid crystal device in accordance with a fifth embodiment.

In the embodiment, the three-dimensional pattern layer 52 is arranged above the gate line 51. After the three-dimensional pattern layer 52 is formed, portions of the three-dimensional pattern layer 52 below the gate, source, or the drain lines are removed such that the gate line 51 is in a recessed structure.

In the embodiment, the liquid crystal device includes a glass substrate 50, a three-dimensional pattern layer 52 protrusively arranged on the glass substrate 50, and the gate line 51 arranged along an outer surface of the three-dimensional pattern layer 52. The three-dimensional pattern layer 52 is arranged on the gate line 51. The three-dimensional pattern layer 52 and the glass substrate 50 form the acute angle α. After being formed, portions of the three-dimensional pattern layer 52 below the gate line 51 are removed such that the gate line 51 is in a recessed structure.

A sixth embodiment relates to a manufacturing method of the liquid crystal device of the fifth embodiment. The manufacturing method includes the following steps. Firstly, a glass substrate is provided. A protrusive three-dimensional pattern layer is arranged on the glass substrate. The three-dimensional pattern layer is arranged above the gate line. The three-dimensional pattern layer and the glass substrate form the acute angle α. After being formed, portions of the three-dimensional pattern layer 52 below the gate, source, or the drain lines are removed by exposure or development processes. The gates and other layers are formed after the three-dimensional pattern layer is formed.

The organic membrane in the fifth and the sixth embodiment not only can increase the aperture ratio but also can act as an insulation layer so as to avoid defects of the substrates.

It is to be understood that the gate line is taken as an example in the above embodiments. Thus, the source line and the drain line are also within the scope of the embodiments.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal device, comprising:
a glass substrate;
a protrusive three-dimensional pattern layer being arranged on the glass substrate, and the three-dimensional pattern layer and the glass substrate form an acute angle; and
a gate, a source, or a drain line being arranged along an outer surface of the three-dimensional pattern layer.

2. The liquid crystal display as claimed in claim 1, wherein the three-dimensional pattern layer is arranged below the gate, the source, or the drain line.

3. The liquid crystal display as claimed in claim 2, wherein the three-dimensional pattern layer includes a top surface, a down surface parallel to the top surface, and two sides connected between the top surface and the down surface, the two sides respectively form the acute angle α with the glass substrate, and the acute angle is of the range between 0 to 90 degrees.

4. The liquid crystal display as claimed in claim 2, wherein the glass substrate includes a down glass substrate and an up glass substrate parallel to each other, the gate line is arranged on the down glass substrate, and the three-dimensional pattern layer is arranged in the area below thicker gate line.

5. The liquid crystal display as claimed in claim 4, wherein a photo spacer is arranged between the three-dimensional pattern layer and the top glass substrate.

6. The liquid crystal display as claimed in claim 1, wherein the three-dimensional pattern layer is arranged above the gate, the source, or the drain line with a recessed structure.

7. The liquid crystal display as claimed in claim 4, wherein the three-dimensional pattern layer is the photo spacer.

8. The liquid crystal display as claimed in claim 6, wherein the three-dimensional pattern layer is the photo spacer

9. The liquid crystal display as claimed in claim 2, wherein the three-dimensional pattern layer is made by organic membrane, and is solidified by ultraviolet rays or heat.

10. The liquid crystal display as claimed in claim 6, wherein the three-dimensional pattern layer is made by organic membrane, and is solidified by ultraviolet rays or heat.

11. The liquid crystal display as claimed in claim 2, wherein the thickness of the three-dimensional pattern layer is of the range between 1 um to 10 um.

12. The liquid crystal display as claimed in claim 6, wherein the thickness of the three-dimensional pattern layer is of the range between 1 um to 10 um.

13. A manufacturing method of a liquid crystal display, comprising:
providing a glass substrate;
arranging a protrusive three-dimensional pattern layer on the glass substrate, and the three-dimensional pattern layer and the glass substrate form an acute angle; and
arranging a gate, a source, or a drain line along an outer surface of the three-dimensional pattern layer, and the three-dimensional pattern layer is below the gate, the source, or the drain lines.

14. The manufacturing method as claimed in claim 13, wherein the three-dimensional pattern layer includes a top surface, a down surface parallel to the top surface, and two sides connected between the top surface and the down surface, the two sides respectively form the acute angle α with the glass substrate, and the acute angle is of the range between 0 to 90 degrees.

15. The manufacturing method as claimed in claim 14, wherein the glass substrate includes a down glass substrate and an up glass substrate parallel to each other, and the gate line is arranged on the down glass substrate, and the three-dimensional pattern layer is arranged in the area below thicker gate line.

16. The manufacturing method as claimed in claim 15, the method further comprises arranging a photo spacer between the three-dimensional pattern layer and the top glass substrate.

17. A manufacturing method of a liquid crystal display, comprising:
providing a glass substrate;
arranging a protrusive three-dimensional pattern layer on the glass substrate, and the three-dimensional pattern layer and the glass substrate form an acute angle; and
arranging a gate, a source, or a drain line along an outer surface of the three-dimensional pattern layer, and the three-dimensional pattern layer is above the gate, the source, or the drain lines; and
after the three-dimensional pattern layer is formed, portions of the three-dimensional pattern layer below the gate, source, or the drain lines are removed by exposure or development processes.
